(19) United States
(12) Patent Application Publication
(10) Pub. No.: US 2008/0135631 A1
(43) Pub. Date: Jun. 12, 2008

(54) Multiple card product with multiple data strips

(76) Inventor: Craig A. Miller, Belvidere, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/636,745

(22) Filed: Dec. 11, 2006

(51) Int. Cl. G06K 19/06

(52) U.S. Cl. 235/493

(57) ABSTRACT

A multi-piece card is provided including a plastic substrate having a first edge, a second edge, a third edge, and a fourth edge. The first edge opposes the second edge, and the third edge opposes the fourth edge. A first separation line extends from the first edge to the second edge and divides the plastic substrate into a first member and a second member. A first data-encoded strip is associated with the first member, and a second data-encoded strip is associated with the second member. The first member is connected such that it may be removed from the second member at the first separation line.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a product having multiple cards with multiple data members, and more specifically to a substantially planar plastic substrate that is separable into multiple plastic cards, a plurality of the cards generally having at least one magnetic data encoded strip.

### BACKGROUND OF THE INVENTION

Financial and gift cards are well known in the art. Standard financial and gift cards generally comprise a plurality of substrates and films laminated together. While such financial and gift cards according to the prior art provide a number of advantageous features, they nevertheless have certain limitations. The present invention seeks to overcome some of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a multi-piece plastic card carrier made of a single plastic substrate and having multiple magnetic data strips. The multi-piece plastic card carrier is divisible into multiple plastic financial and gift cards with a plurality of the cards having a strip containing data thereon.

According to one embodiment, the multi-piece plastic card comprises a plastic substrate. The plastic substrate has a first edge, a second edge, a third edge, and a fourth edge. The first edge opposes the second edge, and the third edge opposes the fourth edge. The plastic substrate further has a first separation line extending from the first edge to the second edge and dividing the plastic substrate into a first member and a second member. A first data-encoded strip is mechanically associated with the first member and extends proximal the fourth edge, and a second data-encoded strip is mechanically associated with the second member. The first member is removably connected to the second member at the first separation line. In one embodiment, the second data-encoded strip extends distal the third edge of the second member. In another embodiment, the second data-encoded strip is provided proximal the first separation line in the multi-piece plastic card when the first member is connected to the second member. In yet another embodiment, the second data-encoded strip is located proximal an edge of the second member after the second member is separated from the multi-piece plastic card.

According to another embodiment, the multi-piece plastic card further comprises a second separation line extending from the first edge to the second edge of the plastic substrate. The second separation line divides the plastic substrate into a third member adjacent the second member. In this embodiment, the second member is between the first member and the third member. The first and second members are preferably separable from the third member. In one embodiment, the third member is provided without a data encoded strip, and has an aperture to allow the multi-piece plastic card to be retained therethrough.

According to another embodiment, the first data-encoded strip is distinct from the second data-encoded strip. In an alternate embodiment, however, the first data-encoded strip is associated with the second data-encoded strip.

According to another embodiment, the multi-piece plastic card comprises a multi-layered plastic substrate with a first component removably connected to a second component at a break in the plastic substrate. The first component is co-planar with the second component when connected to the second component, and has a first data strip positioned adjacent an outer edge thereof. The multi-piece plastic card further comprises a second data strip on the second component and positioned a substantial distance from an outer edge of the plastic substrate when the second component is connected to the first component. However, the second data strip is positioned proximal an outer edge of the second component when the first component is removed from the second component.

According to another embodiment, the multi-piece card comprises a plastic substrate divided into first, second and third removably connected cards. The first card being removably connected to the second card at a first break line in the plastic substrate, and the third card being removably connected to the second card at a second break line in the plastic substrate. The multi-piece plastic card further has a first data strip positioned on the first card adjacent an outer edge thereof and a second data strip positioned on the second card. The second data strip is positioned on the second card a substantial distance from an outer edge of the plastic substrate when the second card is connected to the first and third cards. The second data strip is also positioned proximal an outer edge of the second card when the second card is removed from the plastic substrate.

According to another embodiment, the first, second and third cards are co-planar. Further, an edge of the first card is connected to an edge of the second card and another edge of the second card is connected to an edge of the third card. In another embodiment, the multi-piece card has an aperture in the third card.

According to another embodiment, the multi-piece plastic card comprises a plastic substrate having a top edge and a bottom edge, and is divided into a first component removably connected to a second component at a first break line in the plastic substrate. A portion of the first break line is generally parallel to at least one of the top and bottom edge. Additionally, a data encoded strip is located on one of the first and second components, and it is positioned thereon distal an edge of the plastic substrate.

According to another embodiment, the multi-piece plastic card comprises a plastic substrate having a first component removably connected to a second component at a first break line in the plastic substrate, a first data encoded member on the first component, and a second data encoded member on the second component. The data encoded member is positioned adjacent an outer edge of the first component, and the second data encoded member is positioned adjacent an outer edge of the second component.

According to another embodiment, the first data encoded member and the second data encoded member are positioned proximal the first break line in the plastic substrate. The first data encoded member is encoded with first data and the second data encoded member is encoded with second data. The first data is associated with the second data.

According to another embodiment, pin data is located on one of the first and second components. In a further embodiment there is a removable covering over the pin data. In another embodiment, a separate bar code data is on one of the first and second components.

According to another embodiment, the first component meets size specifications for a CR80 card. In a further embodiment, the second component also meets size specifications for a CR80 card.

According to yet another embodiment, the data encoded members comprise magnetic data strips. In a further embodiment, the data encoded in the first data encoded strip is different, but associated with the data encoded in the second data encoded strip.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front view of one embodiment of a multi-piece plastic card;

FIG. 2 is a front view of another embodiment of a multi-piece plastic card;

FIG. 3 is a front view of the multi-piece plastic card of FIG. 2, with the first, second and third card components separated from one another;

FIG. 4 is a front view of another embodiment of a multi-piece plastic card;

FIG. 5 is a front view of another embodiment of a multi-piece plastic card;

FIG. 6 is a front view of the multi-piece plastic card of FIG. 4, with the first and second card components separated from one another;

FIG. 7 is an end view of one embodiment of a multi-piece plastic card encoder;

FIG. 8 is an end view of another embodiment of a multi-piece plastic card encoder; and,

FIG. 9 is a perspective view of another embodiment of a multi-piece plastic card encoder.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

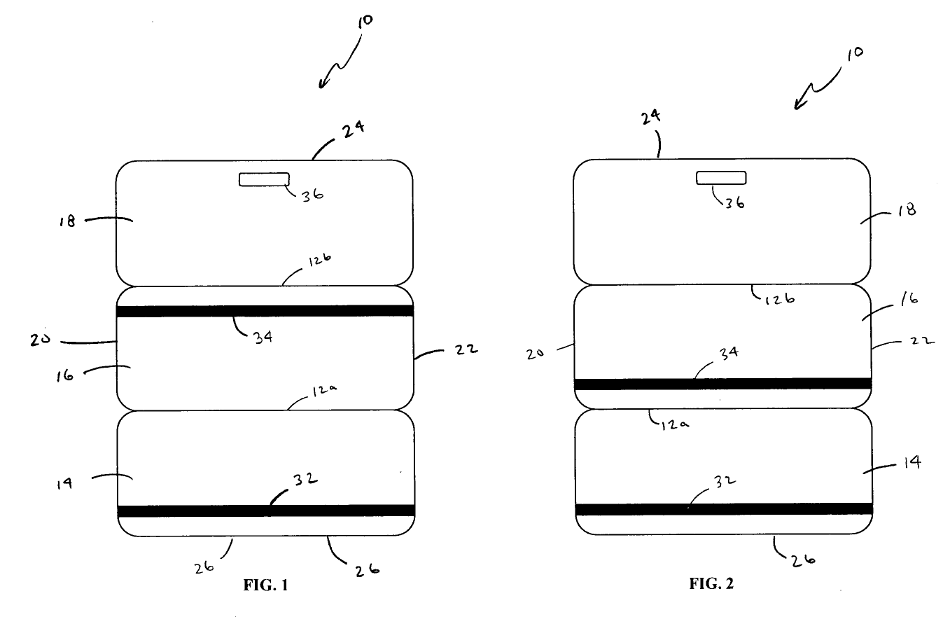

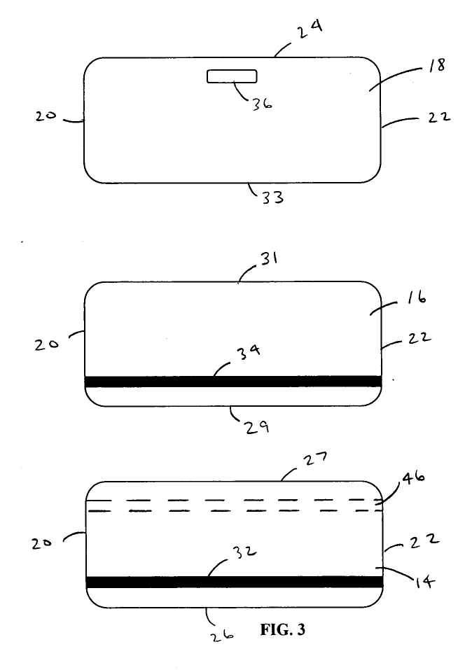

Referring now to the Figures, and specifically to FIGS. 1-3, there is shown one embodiment of a multi-piece card 10 being comprised of a plastic substrate having at least one break or separation line 12. In this embodiment two separation lines 12a and 12b are provided and divide the card into a first card 14, a second card 16 and a third card 18. Accordingly, the first card 14 is removably connected to the second card 16 (i.e., in a first position as shown in FIG. 2 the first card 14 is connected to the second card 16, but with the use of a certain force the first card 14 may be separated from the second card 16 at the break like 12a—as shown in FIG. 3, thus the reference to the removable connection), the third card 18 is removably connected to the second card 16 at the second break like 12b, and the second card 16 is removably connected to both the first card 14 (at the first break line 12a) and the third card 18 (at the second break line 12b). The separation lines 12 may be a break line, a score, material perforation, a depression, a ridge, or other means known in the art that will control the location of the break or separation upon application of a force to the multi-piece card 10. In one embodiment at least one of the first, second or third card components 14, 16, 18 takes the form of a financial card, bank card, gift card, etc., and has a size which meets CR80 specifications.

Typically, printing is provided on a portion of the multi-piece card 10. The printing may be utilized to provide a frame for the card 10, to provide a background for the card 10, as well as to provide indicia for the card 10. For example, in the embodiments illustrated in FIGS. 1-4, various printing may be provided on the multi-piece card 10.

In a preferred embodiment, the multi-piece card 10 is made of a generally rigid (i.e., it is able to maintain its form and shape, but can still be flexed and bent to a degree without breaking and will return to its original shape) plastic material, and is substantially planar (i.e., generally flat) in its finished form. Additionally, in a preferred embodiment the multi-piece card 10 is generally opaque. This may be accomplished through material properties, or through a coating. Alternatively, the multi-piece card 10 could be transparent or translucent. In a preferred embodiment, the multi-piece card 10 is made of a solid core PVC material, however, it is understood that other substrates, as well as different materials, may be utilized. Additionally, other layers such as an outer coating may be laminated or printed, for example by lithographic or silkscreen means, on the core member.

The multi-piece card 10 also has a plurality of edges. In one embodiment wherein the card 10 is generally rectangular or square, the card 10 has a first edge 20, a second edge 22 opposing the first edge 20, a third edge 24 and a fourth edge 26 opposing the third edge 24. The edges 20, 22, 24, 26 of the card 10 define a perimeter thereof. While various embodiments of the card are shown as having a generally rectangular shape, it is understood by those of ordinary skill in the art that any other shape may be employed for the card without departing from the scope and spirit of the present invention.

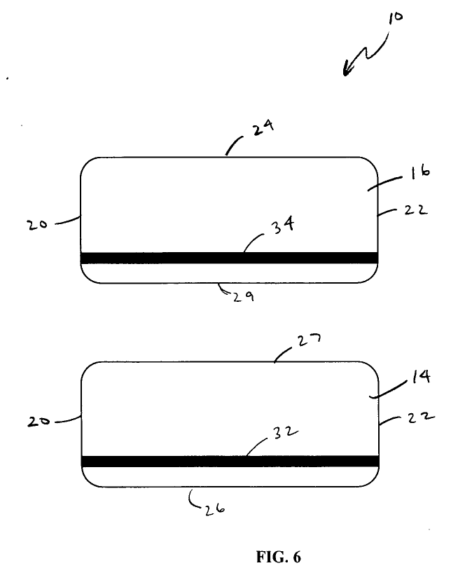

The multi-piece card 10 further may have a first separation or break line 12a and a second separation line 12b. In a preferred embodiment, each of the break lines extends from the first edge 20 to the second edge 22 of the card 10. In alternate embodiments, the multi-piece cards may have additional separation or break lines to further divide the card 10 into additional card members. The first break line 12a may be generally parallel to at least one of the third edge 24 and the fourth edge 26. The first separation line 12a divides the card 10 into a first card or first member 14, and a second card or second member 16. The separated cards 14, 16 also have outer edges. For example, in the embodiments shown in FIGS. 3 and 6, the first card member 14 has a first edge 20 that was a part of the first edge 20 of the multi-piece card 10, a second edge 22 that was a part of the second edge 22 of the multi-piece card 10, a fourth edge 26 that formed the fourth edge 26 of the multi-piece card 10, and an auxiliary edge 27 opposing the fourth edge 26. The auxiliary edge 27 is the edge of the first card 14 that results when the first card 14 is removed or separated from the multi-piece card carrier 10 at the first break line 12a by snapping or breaking-away the first card 14 from the multi-piece card 10.

Referring to the embodiment of FIG. 6, when the second card 16 is separated from the multi-card carrier 10, the second card 16 has a plurality of edges. Specifically, in this embodiment the second card 16 has a first edge 20 that was a part of the first edge 20 of the multi-piece card 10, a second edge 22 that was a part of the second edge 22 of the multi-piece card 10, a third edge 24 that formed the third edge 24 of the multi-piece card 10, and an auxiliary edge 29 opposing the third edge 24. The auxiliary edge 29 is the edge of the second card 16 that results when the second card 16 is removed or separated from the multi-piece card carrier 10 at the first break line 12a by snapping or breaking away the second card 16 from the multi-piece card 10. Accordingly, when the first and second cards 14, 16 are still joined and a part of the multi-piece card 10, the portion of the first card 14 that forms the auxiliary edge 27 of the first card 14 when the first card 14 is separated from the card carrier 10 is connected to the portion of the second card 16 that forms the auxiliary edge 29 of the second card 16 when the second card 16 is separated from the card carrier 10 at the first break line 12a.

The first separation line 12a is formed such that the first member 14 may be removed and separated from the second member 16 of the card 10. The card 10 further may have a second separation line 12b extending from the first edge 20 to the second edge 22 of the multi-piece card 10, as shown in FIGS. 1-3. The second separation line 12b further divides the card into a third member 18, where the second member 16 is located between the first member 14 and the third member 18. The three card members 14, 16, 18 may all be freely separable from one another.

Referring now to the embodiment of FIG. 3, when the second card 16 is separated from the multi-card carrier 10, the second card 16 has a plurality of edges. Specifically, in this embodiment the second card 16 has a first edge 20 that was a part of the first edge 20 of the multi-piece card 10, a second edge 22 that was a part of the second edge 22 of the multi-piece card 10, and an auxiliary edge 29 opposing another auxiliary edge 31. Auxiliary edge 29 is the edge of the second card 16 that results when the second card 16 is removed or separated from the multi-piece card carrier 10 at the first break line 12a by snapping or breaking away the second card 16 from the multi-piece card 10, and auxiliary edge 31 is the edge of the second card 16 that results when the second card 16 is removed or separated from the multi-piece card carrier 10 at the second break line 12b by snapping or breaking away the second card 16 from the multi-piece card 10. Accordingly, when the first, second, and third cards 14, 16, 18 are still joined and a part of the multi-piece card 10, the portion of the first card 14 that forms the auxiliary edge 27 of the first card 14 when the first card 14 is separated from the card carrier 10 is connected to the portion of the second card 16 that forms the auxiliary edge 29 of the second card 16 when the second card 16 is separated from the card carrier 10 at the first break line 12a. And the portion of the third card 16 that forms the auxiliary edge 33 of the third card 18 when the third card 18 is separated from the card carrier 10 is connected to the portion of the second card 16 that forms the auxiliary edge 31 of the second card 16 when the second card 16 is separated from the card carrier 10 at the second break line 12b.

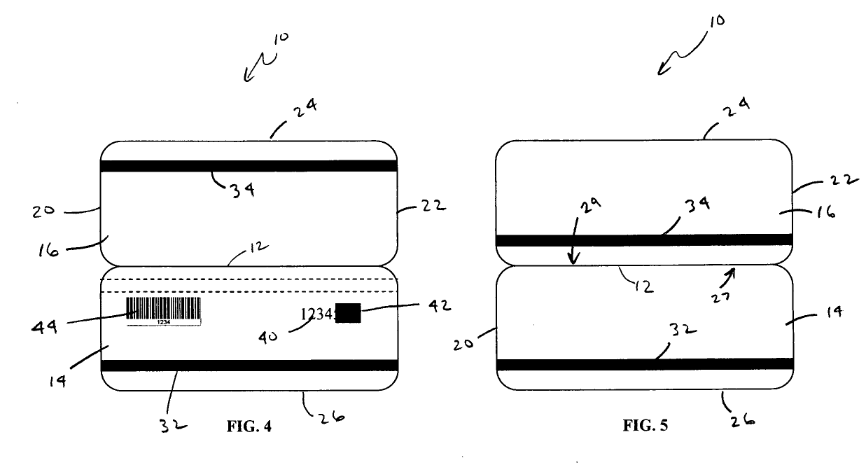

Referring now to FIG. 4, there is shown a two component multi-piece card 10 having a break line 12a to divide the multi-piece card 10 into a first component 14 and a second component 16. As with all preferred embodiments, the first component 14 is coplanar with the second component 16 when they are attached. This is because in the preferred embodiment the card 10 is made of a sheet of material (or multiple layers of sheets). The first card component 14 has a first data strip 32 positioned adjacent an outer edge 26 of both the first component 14 and the overall card 10. The second component 16 has a second data strip 34 positioned adjacent an outer edge 24 of the multi-piece card 10 when the second component 16 is connected to the first component 14. Further, when the first component 14 is removed or separated from the second component 16 the second data strip 34 is located distal an outer edge 29 of the second component 16.

Referring now to FIG. 5, there is shown a multi-piece card 10 having a break line 12a to divide the multi-piece card 10 into a first component 14 and a second component 16. The first card component 14 has a first data strip 32 positioned adjacent an outer edge 26 of both the first component 14 and the overall card carrier 10. The second component 16 has a second data strip 34 positioned distal or a substantial distance from the upper and lower outer edges 24, 26 of the multi-piece card 10 when the second component 16 is connected to the first component 14. When the second component 16 is separated from the first component 14, however, the second data strip 34 in one embodiment may then be located proximal or near an outer edge of the second component 16, and in this embodiment is proximal the auxiliary edge 29 of the second card component 16, as shown in FIG. 6.

The multi-piece card 10 may also contain pin data 40, as shown in FIG. 4. There may also be a covering 42 (shown as a partial covering in FIG. 4) over the pin data 40 that will allow a user to scratch or remove the covering 42 easily to expose the pin data 40. As shown in FIG. 4, a portion of the covering 42 is removed to display the underlying pin data 40. The multi-piece card 10 may further contain a bar code 44 on either the first card 14, the second card 16 or both. In another embodiment a third data strip 46 (shown in phantom on the first card 14 in FIG. 3), may be located on either the first component 14 or the second component 16.

The data strips are provided on the card 10 utilizing known techniques, including various mechanical techniques. The first data strip or member 32 may be encoded with data using methods known in the art to store information and allow for readability of the strip through various scanning devices. For example, the data strip may be comprised of bar code or other visual data, magnetic data, multiple data lines, information in multiple languages, machine readable optical characters, storage data, or any other well known manner of machine readable data. In one embodiment, the first data encoded member 32 may be positioned adjacent an outer edge of the first card 14, and a second data strip 34 may be positioned adjacent an outer edge of the second card 16. The data stored on the first data strip 32 may be different than the data stored on the second data strip 34. In one embodiment, however, the data stored on the first data strip 32 is associated with the data stored on the second data strip 34.

Referring to FIG. 1, the first data strip 32 extends proximal (i.e., near) the fourth edge 26 of the card 10. The card 10 further has a second data strip or member 34 associated with or on the second member 16. The second data strip 34 is positioned on the multi-piece card 10 and distal the third edge 24 of the overall card 10 prior to separation of the first card 14 and after separation of the first card 14 such that the second data strip 34 is not able to be encoded or swiped using traditional encoding devices because it is not positioned adjacent an edge of the card 10. Traditional encoding devices require the magnetic data strip to be positioned adjacent an edge of a card for encoding thereof. In this embodiment, the second data strip 34 extends distal (i.e., located a distance from, such as being at least 25% of the overall length away) the third edge 24 of both the overall card carrier 10 and the second member 16. The second data strip 34 may also be proximal the first separation line 12a in the card 10 when the first card 14 is connected to the second card 16 as shown in FIGS. 2 and 5, or distal the first separation line 12a as shown in FIGS. 1 and 4. In several embodiments, the second data strip 34, is located and preferably requires programming such that it cannot be encoded or swiped with standard encoding/swiping devices because of its location on the card 10 distal an outer edge thereof. The first data strip 32 and the second data strip 34 may both be of a material known in the art that may be programmed with the use of magnetization instruments.

Generally, traditional magnetic strips contain up to three “tracks” of data, identified as tracks 1, 2 and 3. Each track has a different encoded (written) format. In one embodiment, track 1 contains up to 79 alphanumeric characters, and tracks 2 and 3 contain only numeric characters, 40 and 107 characters, respectively. Thus, an encoder or programmer 50 is utilized to write the data on the appropriate track of the magnetic strips.

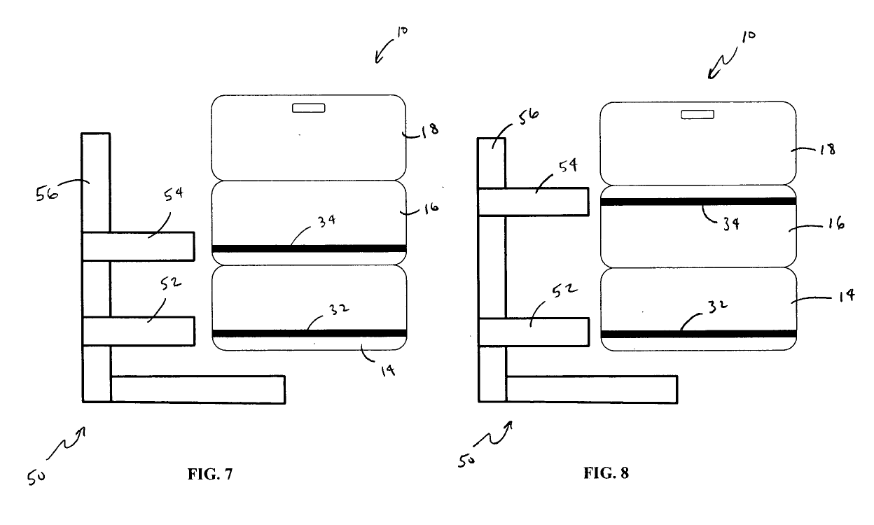

As shown in FIGS. 7-9, the multi-piece card 10 having a plurality of data strips preferably requires at least a dual head programming/encoding process in order to simultaneously encode the multiple data strips when all the card components 14, 16, 18 are connected to the card carrier 10, that is prior to separation of any card member 14, 16, 18 from the card carrier 10. The programming/encoding may be accomplished by a manual or automatic encoding process. Typically, an automatic encoding process that employs driven members to transition the cards 10 through the programming/encoding unit 50 is preferred by one of ordinary skill in the art. In one embodiment, the while being programmed/encoded a retainer 48 may be utilized for securing the multi-piece card to a conveyor (not shown) or other method to allow for repeated and high speed programming of the multi-piece card 10 units. The retainer 48 should be mounted such that when the multi-piece card 10 is passing the programming unit 50 the first data strip 32 is laterally exposed to a first programming head 52, the second data strip 34 is laterally exposed to a second programming head 54, and any additional data strips 34 are exposed to other programming heads 54. In one embodiment the first programming head 52 and the second programming head 54 utilize magnetic technology to program the data strips 32, 34. In alternate embodiments the programming unit 50 has the ability to write data directly on the multi-piece card 10 providing the card 10 with graphical or other visual scanning means.

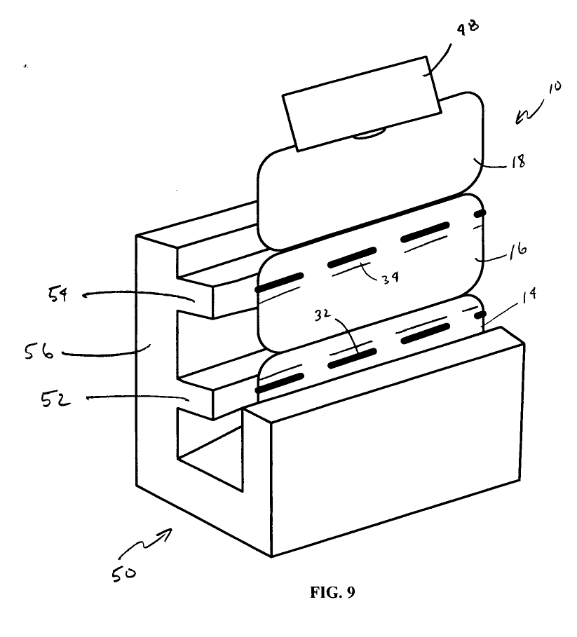

In one embodiment, as shown in FIGS. 7, 8, the first programming head 52 is fixed and the second programming head 54 is vertically adjustable along a support member 56 of the programming/encoding unit 50 to allow for programming of the second data strip 34 on the multi-piece card 10, regardless of the location of the second data strip 34. The second programming head 54 may be locationally adjustable to maintain the second programming head 34 in alignment with the second data strip 34, allowing the multi-piece card 10 to have both data strips 32, 34 programmed simultaneously. The second programming head 54 is able to program the second data strip 34 with either associated data as that programmed on the first data strip 32, or with different information that is programmed by the first programming head 52 on the first data strip 32. In further embodiments the support member 56 may be provided with additional programming heads to allow for the multi-piece card 10 to contain more than two data strips, and still be able to have all data strips programmed simultaneously while being scanned through during a single encoding process.

The first data strip 32 and the second data strip 34 may contain identical data, or in another embodiment may contain different data. In one embodiment, the first data strip 32 is referred to as the child data strip 32 in a parent-child relationship, with the second data strip 34 being referred to as the parent data strip 34. In this relationship, different information may be encoded on the data strips 32, 34, however a central server or some other electronic means will maintain a record of the relationship between the cards. Accordingly, at least some of the data encoded on the two strips 32, 34 is associated. Any known method of associating the information contained on the first data strip 32 with the information on the second data strip 34 may be used. The central server, may then be linked with a credit card server or the specific retail server using preferably a high speed connection (i.e., computer network, telephone line, modem, wireless connection, internet connection, etc.) such that when the second data strip 34 is read by a card reader with access to the central server the second data strip 34 will automatically be associated with the account assigned to the information on the first data strip 32. For example, the parent strip 34, may be used to add funds or money to the account associated with the child strip 32.

In another embodiment, the data strips 32, 34 may have at least some different information as a security measure. In a retail environment, it is common to have a first data strip 32 exposed, such as along an edge of the card carrier 10. This first data strip 32, if it is the only data strip associated with the card, is susceptible to imaging and counterfeiting of the card, due to the ability to read the data on the strip 32 and subsequently write that data to a fraudulent card. The presence of a second data strip 34, however, allows a retailer to assign one data strip for adding money or funds, and the other data strip may be assigned by the retailer for spending the funds or money placed on the card. As shown in FIG. 2, the first card 14 containing the first data strip 32, may be exposed and may be freely scanned by a card reader. In this embodiment, the first data strip 32 will be for adding funds or money to an account associated with the second data strip 34. Because the second data strip 34 is located on the second card 16 and is protected by the first break line 12a, the only means to access the second data strip 34 with a standard card reader is to separate the second card component 16 from the first card component 14, thereby providing additional security to the second data strip 34. After separation of the second card component 16 from the first card component 14, the second data strip 34 will be located proximal an edge of the second member 16. Ideally, this allows an appropriate purchaser access to spend funds because the second data strip 34 is protected from illegal scanning due to its placement on the card carrier 10.

In the embodiment of FIG. 1, the third member 18 is provided without a data strip. In this embodiment, the third member 18 is provided with an aperture 36, or opening, that allows for the card 10 to be retained or hung from a hanger.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A multi-piece plastic card, comprising:
a plastic substrate having a first edge, a second edge, a third edge, and a fourth edge, wherein the first edge opposes the second edge, and wherein the third edge opposes the fourth edge, a first separation line extending from the first edge to the second edge and dividing the plastic substrate into a first member and a second member, a first data-encoded magnetic strip mechanically associated with the first member and extending proximal the fourth edge, and a second data-encoded magnetic strip mechanically associated with the second member, wherein the first member is removably connected to the second member at the first separation line.

2. The multi-piece plastic card of claim 1, wherein the second data-encoded magnetic strip extends distal the third edge of the second member.

3. The multi-piece plastic card of claim 1, wherein the second data-encoded magnetic strip is proximal the first separation line in the multi-piece plastic card when the first member is connected to the second member.

4. The multi-piece plastic card of claim 1, wherein the second data-encoded magnetic strip is proximal an edge of the second member after the second member is separated from the multi-piece plastic card.

5. The multi-piece plastic card of claim 1, further comprising a second separation line extending from the first edge to the second edge of the plastic substrate, the second separation line further dividing the plastic substrate into a third member adjacent the second member, the second member being between the first member and the third member.

6. The multi-piece plastic card of claim 5, wherein the first and second member are separable from the third member.

7. The multi-piece plastic card of claim 5, wherein the third member is provided without a data-encoded magnetic strip.

8. The multi-piece plastic card of claim 5, further comprising an aperture in the third member to allow the plastic card to be retained therethrough.

9. The multi-piece plastic card of claim 1, wherein the first data-encoded magnetic strip is distinct from the second data-encoded magnetic strip.

10. A multi-piece plastic card, comprising:
a multi-layered plastic substrate having a first component removably connected to a second component at a break in the plastic substrate, the first component being co-planar with the second component when connected to the second component;
a first data magnetic strip positioned adjacent an outer edge of the first component; and,
a second data magnetic strip on the second component and positioned a substantial distance from an outer edge of the plastic substrate when the second component is connected to the first component.

11. The multi-piece plastic card of claim 10, wherein the second data magnetic strip is positioned proximal an outer edge of the second component when the first component is removed from the second component.

12. The multi-piece plastic card of claim 10, further comprising a third data magnetic strip on one of the first and second components.

13. A multi-piece card, comprising:
a plastic substrate divided into first, second and third removably connected cards, the first card being removably connected to the second card at a first break line in the plastic substrate, the third card being removably connected to the second card at a second break line in the plastic substrate;
a first data strip positioned on the first card adjacent an outer edge thereof; and,
a second data strip positioned on the second card.

14. The multi-piece card of claim 13, wherein the second data strip is positioned on the second card a substantial distance from an outer edge of the plastic substrate when the second card is connected to the first and third cards.

15. The multi-piece card of clam 14, wherein the second data strip is positioned proximal an outer edge of the second card when the second card is removed from the plastic substrate.

16. The multi-piece card of claim 13, wherein when connected the first, second and third cards are co-planar, an edge of the first card being connected to an edge of the second card, and another edge of the second card being connected to an edge of the third card.

17. The multi-piece card of claim 13, further comprising an aperture in the third card.

18. A multi-piece plastic card, comprising:
a plastic substrate having a top edge and a bottom edge, and being divided into a first component removably connected to a second component at a first break line in the plastic substrate, wherein a portion of the first break line is generally parallel to at least one of the top and bottom edge; and,
a magnetic data encoded strip on one of the first and second components, the magnetic data encoded strip being positioned thereon distal an edge of the plastic substrate.

19. The multi-piece plastic card of claim 18, wherein the magnetic data encoded strip is provided on the second component, and further comprising a second magnetic data encoded strip on the first component proximal an edge of the plastic substrate.

20. A multi-piece plastic card, comprising:
a plastic substrate having a first component removably connected to a second component at a first break line in the plastic substrate;
a first magnetic data encoded member on the first component; and,
a second magnetic data encoded member on the second component.

21. The multi-piece plastic card of claim 20, wherein the first magnetic data encoded member is positioned adjacent an outer edge of the first component, and wherein the second magnetic data encoded member is positioned adjacent an outer edge of the second component.

22. The multi-piece plastic card of claim 20, wherein both the first magnetic data encoded member and the second magnetic data encoded member are positioned distal the first break line in the plastic substrate.

23. The multi-piece plastic card of claim 20, wherein one of the first magnetic data encoded member and the second magnetic data encoded member is positioned proximal the first break line in the plastic substrate.

24. The multi-piece plastic card of claim 20, wherein the first magnetic data encoded member is encoded with first data, wherein the second magnetic data encoded member is encoded with second data, and wherein the first data is associated with the second data.

25. The multi-piece plastic card of claim 20, further comprising pin data located on one of the first and second components.

26. The multi-piece plastic card of claim 25, further comprising a removable covering over the pin data.

27. The multi-piece plastic card of claim 20, further comprising separate bar code data on one of the first and second components.

28. The multi-piece plastic card of claim 20, wherein the first component meets size specifications for a CR80 card.

29. The multi-piece plastic card of claim 28, wherein the second component meets size specifications for a CR80 card.

30. The multi-piece plastic card of claim 20, wherein the data encoded in the first data encoded strip is different, but associated with the data encoded in the second data encoded strip.
